(19) United States
(12) Patent Application Publication
(10) Pub. No.: US 2018/0107793 A1
(43) Pub. Date: Apr. 19, 2018

(54) HEALTH ACTIVITY MONITORING AND WORK SCHEDULING

(71) Applicant: Microsoft Technology Licensing, LLC, Redmond, WA (US)

(72) Inventors: Tachen C. Ni, Bellevue, WA (US); Ryen William White, Woodinville, WA (US); Jessica Lundin, Seattle, WA (US)

(73) Assignee: Microsoft Technology Licensing, LLC, Redmond, WA (US)

(21) Appl. No.: 15/297,077

(22) Filed: Oct. 18, 2016

(51) Int. Cl. G06F 19/00; G06Q 10/10

(52) U.S. Cl. CPC G06F 19/322; G06F 19/3481; G06Q 10/1095

(57) ABSTRACT

Examples are disclosed herein that relate to correlating health data outcomes to work data of a user and recommending future work activities based upon the correlation. One example provides a computing device configured to monitor health data relating to health behavior of a user over time, determine a baseline value for a health outcome of the user based on the monitored health data, and receive work data relating to a work schedule of the user. Responsive to the health outcome deviating from the baseline value, the computing device is configured to determine that the deviation in the health outcome correlates with the work data, and based at least upon determining that the deviation in the health outcome correlates with the work data, output a notification of the determination to the user.

### BACKGROUND

Electronic devices, such as wearables and smart phones, may be configured to track and output information regarding physiological and behavioral characteristics of a person, such as health and fitness data.

### SUMMARY

Examples are disclosed that relate to correlating health data outcomes to work data of a user and recommending future work or fitness activities based upon the correlation. One example provides a computing device configured to monitor health data relating to health behavior of a user over time, determine a baseline value for a health outcome of the user based on the monitored health data, and receive work data relating to a work schedule of the user. Responsive to the health outcome deviating from the baseline value, the computing device is configured to determine that the deviation in the health outcome correlates with the work data, and based at least upon determining that the deviation in the health outcome correlates with the work data, output a notification of the determination to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A shows an example user interface for health data monitoring displayed on an example computing device.

FIG. 1B shows an example user interface for work data monitoring displayed on an example computing device.

FIG. 1C shows an example user interface for a personal calendar displayed on an example computing device, and illustrates an example scheduling alert.

FIG. 1D shows an example user interface for integrating health and work data monitoring displayed on an example computing device.

FIGS. 2A and 2B show an example wearable electronic device.

FIG. 3 shows a block diagram of an example use environment for correlating health data and work data.

FIG. 4 show an example method of providing a recommendation related to detecting a deviation in health data that correlates with work data.

FIG. 5 shows a block diagram of an example computing system.

### DETAILED DESCRIPTION

As mentioned above, various electronic devices, such as wearable or mobile devices, may be configured to track health and fitness-related data for a user based on sensor data. For example, a mobile device may use location sensors and motion sensors to track movements of the user over time. This data then may be used to determine information such as calories burned, distance traveled, average speed traveled, and inactive time. Wearable devices may comprise additional sensors, such as sensors useable to detect heart rate and heart rate variation, blood pressure, blood oxygenation, skin temperature, and galvanic skin response, as examples. Such information may help a user to understand instantaneous health status, and to determine trends in the user's health characteristics over time.

However, such devices may not provide insight into factors that may influence health characteristics over time, such as the impact that work activities (e.g., number and/or duration of meetings on a given day) may have on the user's health characteristics. For example, while it may be recognized that work duration and/or user stress level while at work may impact various health outcomes, there may be little or no recognition for any correlations between other, seemingly routine aspects of work and health outcomes, such as the number and/or duration of meetings attended by a user during a work day compared to the amount of quality sleep achieved by the user that night. Such devices also may not provide feedback on how to vary work activities to help achieve a health outcome of interest.

Accordingly, examples are disclosed that relate to correlating health data with work data to generate insights from correlations between health data deviations and work data, and to thereby provide health-related recommendations for future work activities. In one example, health data of a user may be monitored over time based on output from a variety of sensors associated with one or more electronic devices of the user. The health data may be processed to determine respective baseline values one or more health outcomes, such as sleep quality or exercise efficiency. If the health data indicates that a health outcome deviates from the baseline value for that health outcome, work data of the user may be analyzed to determine whether a correlation exists between any of the work data and the health outcome that exhibited the deviation.

Example health data may include such information as exercise efficiency, exercise benefit, and/or sleep quality as a function of exercise schedule and behavior. Example work data may include calendar data and other information regarding habits and obligations associated with work (e.g., patterns in sending and receiving electronic email). The term “work” as used herein may signify work activities and obligations associated with an occupation, including but not limited to jobs performed at work, work meetings, phone calls, homework, classes, commutes to and from work/school, and business trips. Further, “work data” may signify scheduled or habitual activities associated with work. Work data may also include metrics related to work efficiency, such as rate of jobs or tasks completed, mails sent, keystrokes, mouse clicks, web searches, etc. Further, other obligations besides work may also be considered, including but not limited to social, family, or entertainment events on a user's calendar. More detailed examples of health data, work data, and the comparison of health data and work data are described below.

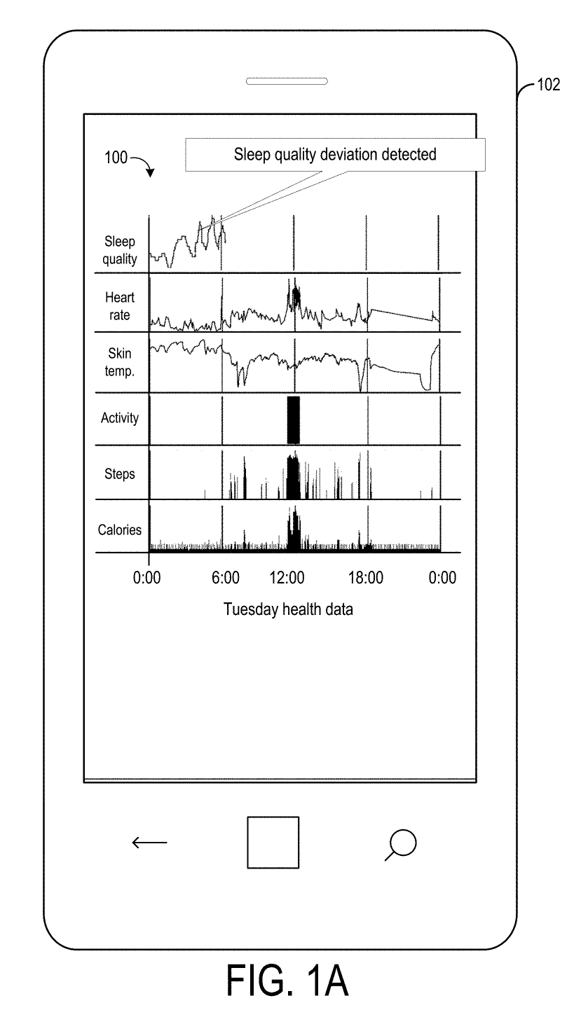

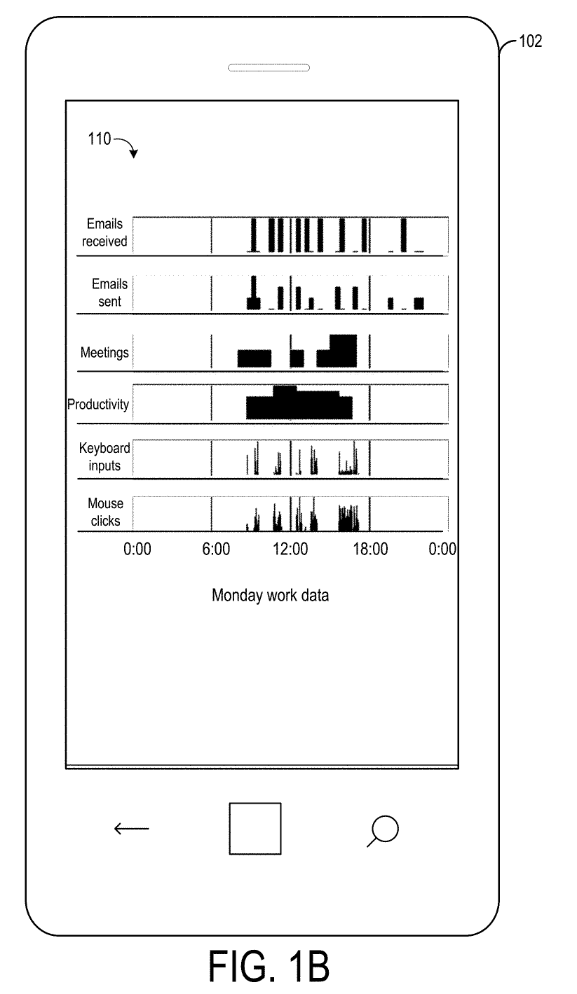

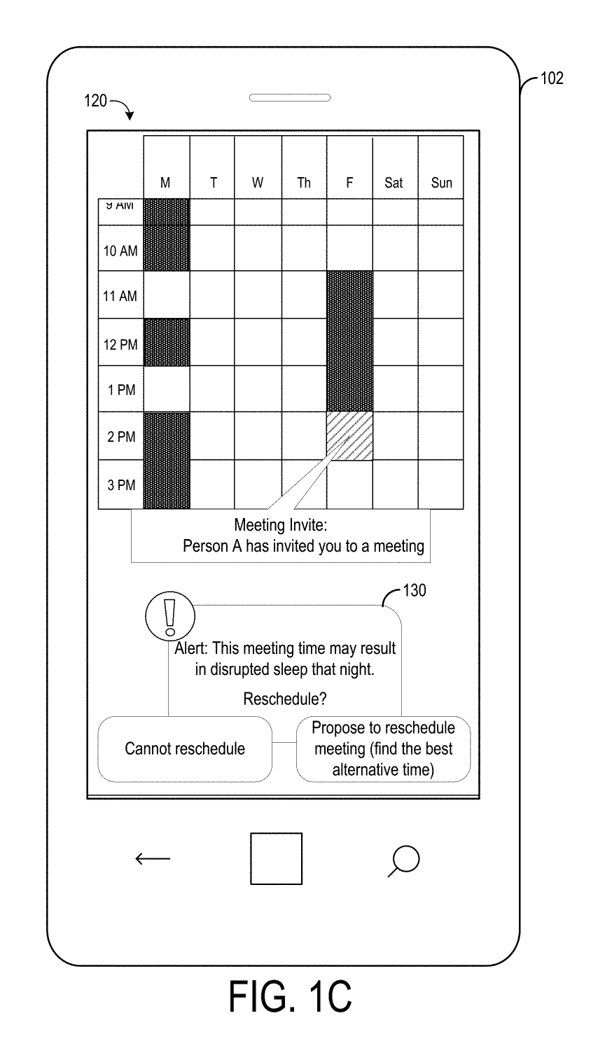

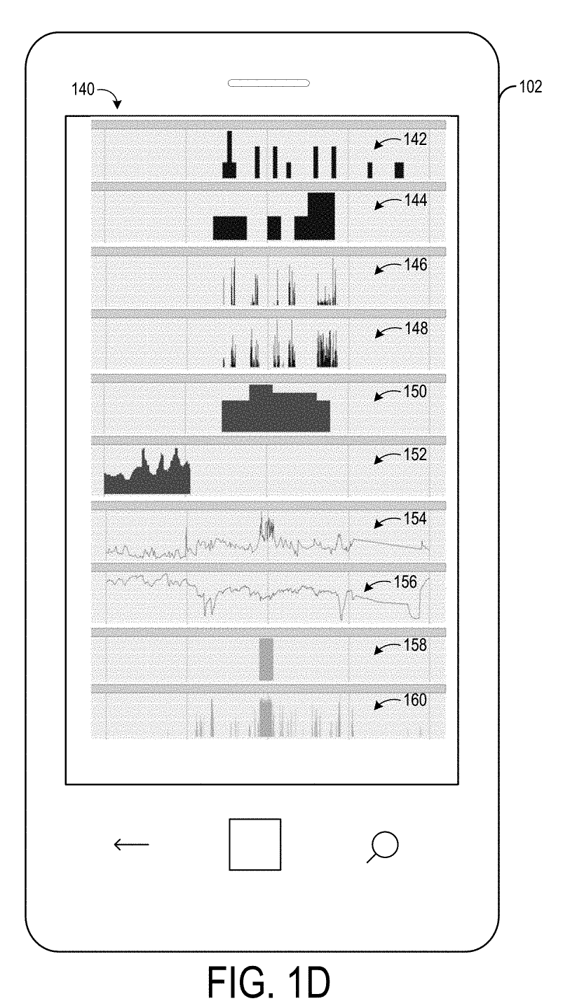

FIG. 1A shows an example health data user interface 100 on an example computing device, depicted as a mobile device 102. Health data user interface 100 includes graphical representations of monitored health data and/or health outcomes. As used herein, health data may include signals obtained from various sensors, such as heart rate sensors, galvanic skin response sensors, and accelerometers, as well as data from processing such signals, while health outcomes may refer to information of interest relating to a user's health as determined from the monitored health data. In some examples, a health outcome may be determined from a single source of health data. For example a user's heart rate may be a health outcome that is derived from a heart rate sensor. In other examples, a health outcome may be determined from analysis of multiple sources of health data and/or health information of the user. For example, a number of calories burned may be determined from heart rate data, location data, and a user's weight, age, height, and/or gender.

As illustrated in FIG. 1A, health data user interface 100 includes graphical representations of sleep quality, heart rate, skin temperature, activity, number of steps, and number of calories burned for a user over a period of time. FIG. 1A shows a 24-hour period, although graphical representations of other health data and/or outcomes are possible (e.g., sleep duration, user stress level, exercise efficiency). By displaying a plurality of graphical representations of health data and/or health outcomes over time, a user may be able to spot trends in his or her health outcomes, identify periods of low activity, or make other determinations to guide health and fitness related outcomes.

While presenting health data to a user may be beneficial, certain trends or correlations between user activities and health outcomes may be more difficult for a user to detect by visualizing the presented health data. Thus, a computing device (e.g., mobile device 102) may be configured to analyze the health data to identify deviations in one or more health outcomes relative to corresponding baseline values. A baseline value for each health outcome of interest for a user may be determined based, for example, on one or more statistical metrics of values for the health outcome based upon the user's past health data, and/or upon data from a broader population. Examples of such metrics are described in more detail below. If a determined health outcome deviates from the baseline value for that health outcome, the computing device may be configured to alert the user, and to determine any possible insights into the deviation by analyzing the health data and work data for the user to determine potential correlations between the deviation in health data and the work data.

As a specific example, mobile device 102 may be configured to analyze health outcomes such as sleep quality, heart rate, skin temperature, activity, number of steps, and calories burned, in order to detect if a deviation in one of the health outcomes has occurred relative to a respective baseline value for that health outcome. For example, sleep quality may be rated on a scale of 0-100 with zero being no sleep and 100 being a highest possible quality of sleep, as determined by e.g., movement, heart rate, and duration of sleep. As shown, a deviation in the user's sleep quality has been detected by the mobile device, as a determined average sleep quality during the illustrated 24-hour time period is lower than a baseline sleep quality value.

In response to detecting the deviation, the user's collected work data may be analyzed in order to determine if any of the user's work activities during a certain time period preceding the deviation correlate with the deviation. FIG. 1B shows a work data user interface 110 displayed on mobile device 102 that includes graphical representations of various work data based on received work data of the user over a 24-hour period preceding the detected sleep quality deviation (e.g., the Monday preceding the Tuesday). As illustrated, work data user interface 110 includes graphical representations of a number of emails received, a number of mails sent, a number of meetings attended per hour, productivity, a number of keyboard inputs, and a number of mouse clicks over the 24-hour period of time.

The work data may be analyzed by the mobile device 102 or another computing device in communication with the mobile device to determine which work activity or activities may have contributed to the deviated health outcome. For example, each type of work data may be compared to an average value (or other statistical value) for that data over a preceding period of time (e.g. a number of emails received during the 24-hour time period illustrated in FIG. 1B may be compared to an average number of emails received each work day over the previous two weeks), and if any work activity data differs from the baseline value for that type of data, it may be determined that the work activity correlates with the deviation in the health outcome. Other mechanisms of identifying which work activity correlate with deviations in health outcomes also may be used, as described in more detail below.

From the example work data illustrated in FIG. 1B, the mobile device 102 may determine that both the number and duration of consecutive meetings the user attended on that Monday (e.g., the five meetings attended over the three hours from 14:00-17:00) correlate with the deviation in the sleep quality the user experienced that evening. As a result of the determination, the mobile device 102 may store information regarding the correlation and then use the correlation to inform future meeting scheduling, for example by notifying the user of potential sleep issues when future meetings are scheduled. An example of a notification output to the user is illustrated in FIG. 1C, which shows a user interface 120 that displays a user's calendar comprising a plurality of scheduled items. In this example, scheduled meetings are shown by the dark blocks while unscheduled time is shown by white blocks. A proposed meeting time is shown by the diagonally-striped box. The meetings that the user attended on that Monday are illustrated, as are future meetings (e.g., a meeting from 11:00 AM-2:00 PM). In addition, the user has received a meeting invite for Friday at 2:00 PM.

Based upon the determination from the user's health data and work data that a relatively high number of meetings in a day and a relatively long duration of back-to-back meetings correlate with lowered sleep quality, the device 102 determines that the user may have a poor night's sleep on Friday night if the user attends the proposed meeting on Friday at 2:00 PM, as attending the meeting would result in four consecutive hours of meetings. As such, the device 102 displays an alert 130 to notify the user of this insight. The depicted alert 130 also may provide the user with one or more selectable options of remedial actions to take, illustrated here as an option to propose to reschedule the meeting. Upon user selection of “reschedule meeting,” the device 102 may, for example, recommend one or more other times for the meeting that are determined to be beneficial based upon the user's work and health data, and that do not coincide with the time of scheduled meetings or other scheduled events. Such a determination also may take into account any other factors than schedule, such as calendar fragmentation (e.g. the rescheduling may offer times that reduce calendar fragmentation), as well as the calendar(s) of other users invited to participate in the meeting. In one example, the notification may include an option for the device to find the best alternative meeting time, for example based on the above-described parameters and/or an option for the user to find the best alternative meeting time.

While the graphical representations of the health data and the graphical representations of the work data are shown on separate interfaces in FIGS. 1A and 1B, in some examples the health data and work data may be represented together, in part or whole, on a single interface or display, for example as shown in FIG. 1D.

FIG. 1D shows a work and health data interface 140 displayed on mobile device 102 that includes graphical representations of various work data based on received work data of the user over a 24-hour period. For example, the top five plots of the interface 140 are graphical representations of work data, including number of emails sent 142, number of meetings per hour 144, number of keyboard inputs 146, number of mouse clicks 148, and productivity 150. The work and health data interface 140 also includes graphical representations of various health data based on received health data of the user over the same 24-hour period. For example, the bottom five plots of the interface 140 are graphical representations of health data, including sleep quality 152, heart rate 154, skin temperature 156, activity intensity 158, and steps per minute 160.

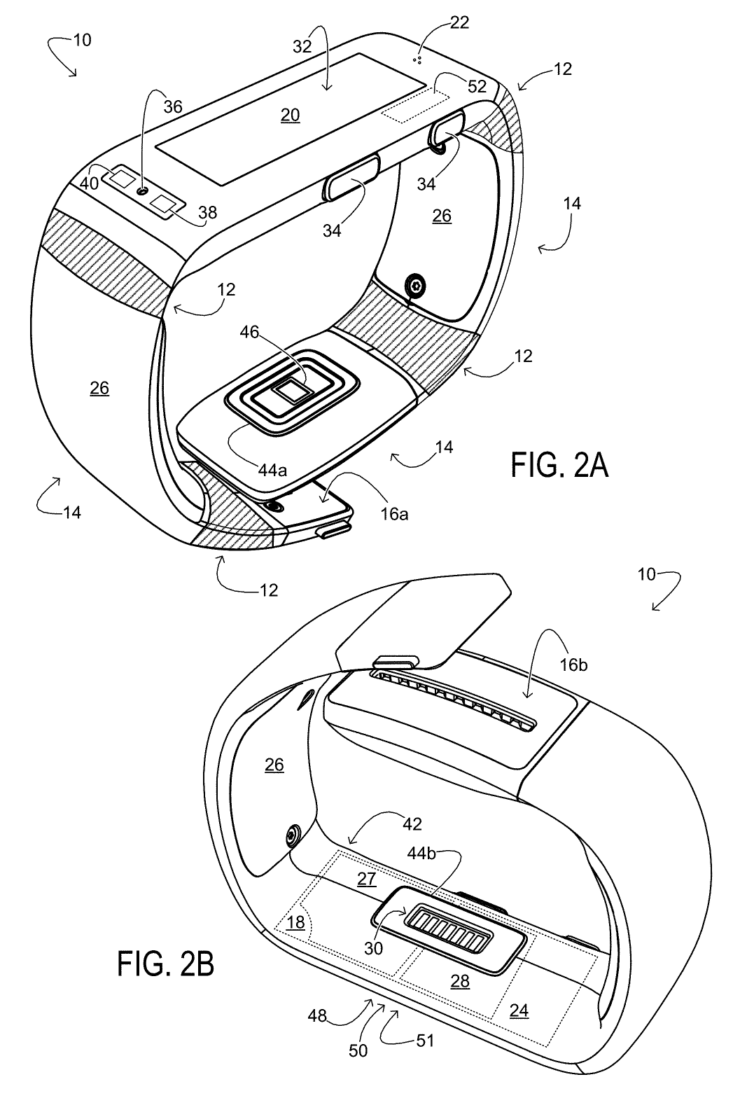

Health data and work data may be obtained from various sources. For example, health data and work data may be determined from sensor data acquired via a wearable or portable sensor system. FIGS. 2A and 2B show aspects of an example sensory-and-logic system in the form of a wearable electronic device 10 that may be configured to track health data and work data, and/or provide sensor data (raw or processed) to a remote device, such as a cloud-based server, a mobile device, and/or desktop computing device, for analysis. The illustrated device is band-shaped and may be worn around a wrist. The depicted wearable electronic device 10 includes a plurality of flexion regions 12 linking less flexible regions 14. The flexion regions 12 of the wearable electronic device 10 may be elastomeric in some examples. Fastening componentry 16a and 16b is arranged at both ends of the wearable electronic device 10. The flexion regions 12 and fastening componentry 16a and 16b enable the wearable electronic device 10 to be closed into a loop and to be worn on a user's wrist. In other examples, wearable electronic devices of a more elongate band shape may be worn around the user's bicep, waist, chest, ankle, leg, head, or other body part. In such an example, a wearable electronic device may take the form of eye glasses, a head band, an arm-band, an ankle band, a chest strap, or an implantable device to be implanted in tissue.

The wearable electronic device 10 includes various functional components integrated into less flexible regions 14. For example, the wearable electronic device 10 includes a computing system 18, display 20, loudspeaker 22, communication suite 24, and various sensors. These components draw power from one or more energy-storage cells 26.

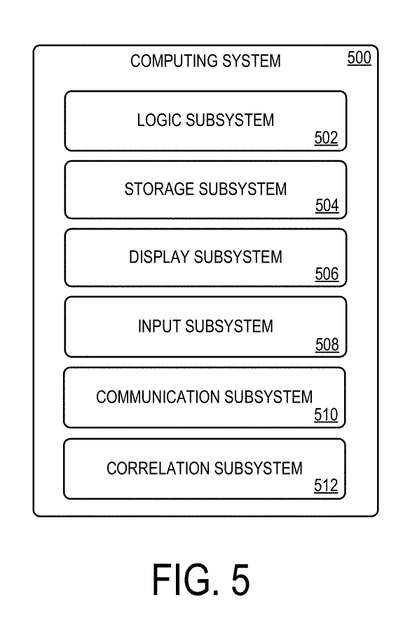

In the wearable electronic device 10, the computing system 18 is situated below the display 20 and operatively coupled to the display 20, along with the loudspeaker 22, the communication suite 24, and the various sensors and other components not depicted (e.g. haptic outputs, such as piezoelectric vibrators). The computing system 18 includes a data-storage machine 27 to hold data and instructions, and a logic machine 28 to execute the instructions. Aspects of the computing system 18 are described in further detail with reference to FIG. 5.

The communication suite 24 may include any appropriate wired or wireless communications componentry. In FIGS. 2A and 2B, the communication suite 24 includes USB port 30, which may be used for exchanging data between the wearable electronic device 10 and other computer systems, as well as providing recharge power. The communication suite 24 may further include two-way Bluetooth, Wi-Fi, cellular, near-field communication and/or other radios. In some examples, the communication suite may include an additional transceiver for optical, line-of-sight (e.g., infrared) communication.

In the wearable electronic device 10, touch-screen sensor 32 is coupled to display 20 and configured to receive touch input from the user. Pushbutton sensors may be used to detect the state of push buttons 34, which may include rockers. Input from the pushbutton sensors may be used to enact a home-key or on-off feature, control audio volume, turn the microphone on or off, etc.

FIGS. 2A and 2B show various other example sensors. Such sensors include microphone 36, visible-light sensor 38, ultraviolet sensor 40, and ambient temperature sensor 42. The microphone 36 provides input to the computing system 18 that may be used to measure the ambient sound level or receive voice commands from the wearer. Input from the visible-light sensor 38, ultraviolet sensor 40, and ambient temperature sensor 42 may be used to assess aspects of the wearer's environment—e.g., the temperature, overall lighting level, and whether the wearer is indoors or outdoors.

FIGS. 2A and 2B further show a pair of contact sensor modules 44a and 44b, which contact the wearer's skin when the wearable electronic device 10 is worn. The contact sensor modules 44a and 44b may include independent or cooperating sensor elements to provide a plurality of sensory functions. For example, the contact sensor modules 44a and 44b may provide an electrical resistance and/or capacitance sensory function responsive to the electrical resistance and/or capacitance of the wearer's skin, and thus may be configured to function as a galvanic skin response sensor. In the illustrated configuration, the separation between the two contact sensors provides a relatively long electrical path length for more accurate measurement of skin resistance compared to a shorter path. Further, in some examples, a skin temperature sensor may be integrated into one or both of contact sensor modules 44a and 44b to provide measurement of the wearer's skin temperature.

The wearable electronic device 10 may also include motion sensing componentry, such as an accelerometer 48, gyroscope 50, and magnetometer 51. The accelerometer 48 and gyroscope 50 may furnish inertial and/or rotation rate data along three orthogonal axes as well as rotational data about the three axes, for a combined six degrees of freedom. This sensory data can be used to provide a pedometer/calorie-counting function, for example. Data from the accelerometer 48 and gyroscope 50 may be combined with geomagnetic data from the magnetometer 51 to further define the inertial and rotational data in terms of geographic orientation. The wearable electronic device 10 may also include a global positioning system (GPS) receiver 52 for determining the wearer's geographic location and/or velocity. In some configurations, the antenna of the GPS receiver 52 may be relatively flexible and extend into flexion regions 12.

The computing system 18, via the sensory functions described herein, is configured to acquire various forms of information about the wearer of the wearable electronic device 10. Such information must be acquired and used with utmost respect for the wearer's privacy. Accordingly, the sensory functions may be enacted subject to opt-in participation of the wearer. In implementations where personal data is collected on the wearable electronic device 10 and transmitted to a remote system for processing, that data may be anonymized. In other examples, personal data may be confined to the wearable electronic device 10, and only non-personal, summary data is transmitted to the remote system.

It will be understood that any other suitable sensors not shown in FIGS. 2A and 2B may be included on the wearable electronic device 10, such as a heart rate monitor, one more optical sensors, a barometer to detect changes in atmosphere pressure, an actigraph/actimetry sensor to monitor sleep behavior, etc. It will further be understood that although FIGS. 2A and 2B show a wearable device, the methods and techniques described herein may be operated on any other suitable computing device, including a desktop computing device, a mobile computing device, other wearable computing devices, and computing devices without sensors that may receive data remotely from a sensory-and-logic device such as wearable electronic device 10.

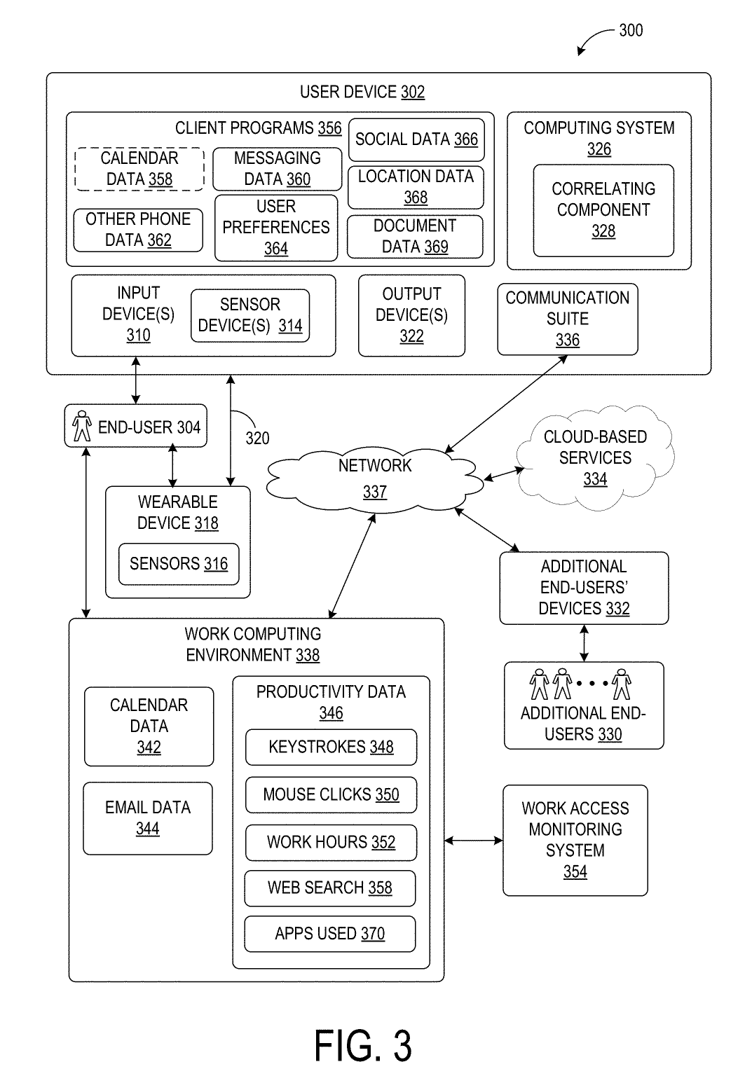

FIG. 3 shows an example use environment 300 including a user device 302 associated with end-user 304. The user device 302 may correspond to any suitable computing apparatus configured to process user health data and work data, such as a smartphone, a tablet, a laptop computer, or a desktop computer. Mobile device 102 of FIGS. 1A-1C and device 10 of FIG. 2 are examples of user device 302. Additional end-users device(s) 332, associated with additional end-users 330, may take similar forms.

The user device 302 includes one or more input devices 310, such as a touch sensor (integrated with or separate from a display), a keyboard and/or a mouse. The input devices 310 also may include one or more sensors 314. In other examples, a user device may not include sensors 314, but may receive sensor data from sensors residing on another device, such as from sensors 316 on wearable device 318. Examples of the wearable device 318 include wrist or ankle-worn devices, head-mounted devices, and clip-on devices, configured to communicate with the user device 302, e.g. via a wired or wireless communication link 320. The user device 302 also includes one or more output devices 322, such as a display, a speaker, and/or a haptic output mechanism. Examples of sensors 314 or sensors 316 include one or more image sensors (e.g. video camera(s) and/or depth camera(s)), one or more microphones, one or more motion sensors (e.g. accelerometers, gyroscopes, magnetometers, etc.), an ultraviolet light sensor, an ambient temperature sensor, a galvanic skin response sensor, a skin temperature sensor, an optical heart rate sensor, a GPS sensor, and a barometer. Raw output from such sensors may be analyzed, for example by a computing system 326 of the user device 302 or directly on the wearable device 318, to determine quantities such as user movements, heart rate, blood pressure, blood oxygenation, calories burned, and sleep-related characteristics (e.g. a number of and frequency of wakeups, cardiovascular activity during sleep, etc.) as a function of time. This information may then be further analyzed to determine measures of sleep quality and one or more exercise benefits, such as exercise efficiency.

Temporal information regarding deviations in sleep quality, exercise benefits, and other such health outcomes may be correlated with user work activities to determine health recommendations for the user, wherein the health recommendations may include information regarding a determined relationship between work activity and deviations in one or more health outcomes. Such relationships may include, for example, positive health outcome deviations (e.g., health benefits and health efficiencies) achieved based on work activities, as well as negative health outcome deviations (e.g., health drawbacks or inefficiencies) that may be experienced based on work activities. Characteristics of the work activities considered in such an analysis may include the types of work activities performed, the times at which work activities are performed, and the duration of the work activities. Example deviations in health outcomes may include deviations in exercise benefits, exercise efficiency, sleep quality, and other outcomes (e.g. body weight, body mass index, and weight loss).

In FIG. 3, the user device 302 may have access via communication suite 336 and network 337 to work data, such as calendar data 342, on a work computing environment 338 of the end-user 304, including but not limited to desktop PCs, laptops, tablets or virtual machines/servers in a cloud computing environment, wherein the work data regards a personal work schedule and/or work habits of the end-user 304. The calendar data 342 may inform the user device 302 of a personal work schedule of the end-user 304, which may be used to determine various parameters related to work activities, including but not limited to a number, duration, and/or timing of meetings.

Work data may also be determined or inferred from other suitable data besides calendar data 342. For example, email data 344 accessible from the work computing environment 338 may help provide data related to times of work meetings and events, as determined from email content, keywords, invitations, etc. Further, email data 344 may also provide information relating to times when a user is logged in to a work email address or has received and sent email correspondences, indicating that the user may likely be working. As another example, work data may be inferred from sensor data provided by the user device 302 and/or the wearable device(s) 318, such as sensor data indicating when the user has been sitting for an extended period of time, GPS data indicating when the user is at a work location, etc.

Work data may further include information related to work productivity of the end-user 304. Productivity data 346 may include, for example, information regarding keystrokes 348, mouse clicks 350, work hours 352 logged, web search activities 358, and/or applications in use 370 via the work computing environment 338. Other examples of productivity data include tasks completed, emails answered (as determined from email data 344), number of print jobs, time spent in screensaver/sleep mode, word count of documents drafted, a number or type of documents edited, etc. In some examples, hours worked may also be accessible from a work access monitoring system 354 used by an employer, such as an employee time entry system, work timesheets, employee work schedules, employee premises access information (e.g. security badge information), and/or payroll.

The user device 302 also may include client programs 356 including client-side calendar functionality, which may reflect the calendar data 342 on the work computing environment 338. The client programs 356 may also provide various messaging data 360, social data 366, location data 368, document (opening, browsing, editing or saving) data 369, user preferences 364, and other phone data 362. Similar to the email data 344, the messaging data 360 may help to inform when the user may have obligations, e.g. from analysis of the content of text invitations, alerts, reminders, and the like. The phone data 362 may provide similar information, e.g. from conversation or voicemail content. Work data may also be received via user input of work hours during an initial configuration or other user input process. As yet another example, work data may also be inferred from GPS data, which may indicate when a user is at a work location.

In addition to sensor data collected by the user device 302, relationships between work activities and health outcomes also may be determined based at least partially on user inputs. User inputs may be used, for example, to indicate a work activity type being performed, an input activating an exercise mode on the user device 302, and/or any other suitable data useable to correlate health outcomes with work activities.

As explained above, deviations identified in the health data compared to baseline health data may be utilized in combination with the work data related to a user's work activities to determine any possible correlations between user work activities and resultant deviations in health outcomes in order to make recommendations to help achieve a desired health outcome. Any suitable correlations between work activities and deviations in health outcomes may be determined. For example, the computing system 326 may determine from sensor data that lower exercise efficiency (e.g. calories burned per minute) may be achieved on days when the user sends email continuously (e.g., at least one email per hour) throughout the day relative to days when the user sends emails in a few discrete blocks of time (e.g., one hour in the morning and one hour in the afternoon). As another example, the computing system 326 may determine that days where the user attends less than three meetings are correlated with better sleep quality compared to days when the user attends three meetings or more. As other examples, the computing system 326 may determine that days where the user is away from his or her computer for a threshold period of time each hour (e.g., 10 consecutive minutes) are correlated with better sleep quality relative to days where the user is unable to leave his or her computer each hour (where time at the computer is determined from mouse clicks and/or keyboard inputs, for example).

In some examples, such correlations also may be determined directly on wearable device 318.

Raw and/or processed sensor data may be analyzed to determine the correlations in any suitable manner. For example, the computing system 326 may comprise a correlating component 328 to apply one or more correlating models and/or algorithms to the acquired data. The correlating component 328 may be configured to determine and/or obtain baseline values for each health outcome and compare the received health data to the baseline values to determine if deviations in one or more health outcomes have occurred. Additionally, the correlating component 328 may be configured to identify any correlations between deviations in health outcomes and work activities, whether in response to detected deviations in one or more health outcomes or in response to a user request. Such correlating components also may be incorporated into wearable device 318.

To determine baseline values for each health outcome, the correlating component 328 may be trained based on health data and/or user health metrics (e.g., personal and/or demographic information), either for the user or for a broader population of users. In some examples, population-based health data may be initially used to determine baseline values for a new user for whom little personal data has been accumulated. Such population data may be obtained from additional end-users 330 and their devices 332 via cloud-based services, illustrated schematically at 334. For example, health data from cohorts of similar individuals (e.g., people who are physiologically similar and have similar work/exercise habits) may be used to determine baseline values. As the end-user 304 continues to use the user device 302, personal data may be applied to analysis as it is gathered. Personal data may eventually override the population data with time. The baseline values may represent an overall average value (e.g., an average sleep quality over a period of time), an average maximum value (e.g., an average maximum heart rate), an average minimum value (e.g., an average minimum sleep duration), a median value, a mode value, or other suitable value.

The correlation component 328 may implement any suitable algorithms or techniques to correlate deviations in health outcomes with work activities. Examples include exploratory factor analysis, multiple correlation analysis, support vector machine, random forest, gradient boosting, decision trees, boosted decision trees, generalized linear models, partial least square classification or regression, branch-and-bound algorithms, neural network models, deep neural networks, convolutional deep neural networks, deep belief networks, and recurrent neural networks.

identified correlations may be used to provide various recommendations to a user. For example, health data regarding deviations in sleep quality, exercise benefits, exercise efficiency, and other suitable outcomes as a function of work activities performed and/or times at which work activities are performed may be used to suggest future work activities in order to avoid future negative health outcome deviations or to encourage future positive health outcomes, where the recommendations related to future work activities may include scheduling of meetings, meeting invitees/attendees, meeting location, meeting topic, meeting modality (e.g., via phone, in person, or video), workflow organization (e.g., how to allocate/schedule various work tasks throughout the day), work schedule and/or location (e.g., if the user has a flexible schedule), and/or other work activities.

In some examples, preferences of the end-user 304 may be used to further inform recommendations for scheduling of future work activities. As such, the client programs 356 may include data regarding user preferences 364. Such preferences may be input by a user, or may correspond to user patterns learned over time. User preferences 364 may comprise any suitable information, such as information regarding when the end-user 304 prefers to leave for and/or return from work, a preferred location of work (where the user has the option to work from home or in the office, for example), a prioritization of certain work meetings compared to other work meetings, etc.

The user device 302 may also interact with any suitable additional user devices, such as another wearable device, another mobile device, a desktop personal computing device, a laptop computing device, a game console device, a set-top box device, or a tablet-type computing device, as examples. Additional user devices may provide any other suitable data for use in helping to recommend scheduling of events.

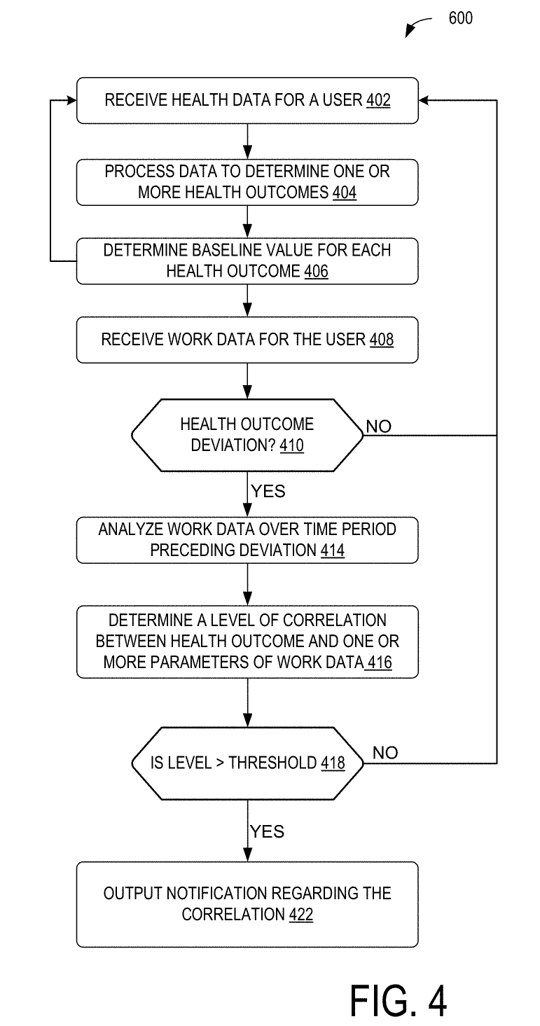

FIG. 4 shows an example method 400 of correlating deviations in health data relative to baseline health data values with work data to determine insights and provide recommendations. The method 400 may be implemented on any suitable user device, such as wearable electronic device 10, mobile device 102, or another computing device (e.g. a remote server, a desktop, laptop, tablet, HMD, or other wearable) in communication with a wearable or mobile device.

The method 400 includes, at 402, receiving health data for a user. The health data may be at least partially derived from sensor data, such as data from various sensors on a wearable device and/or a mobile device. Such sensor data may include data relating to heart rate, skin temperature, galvanic skin response, number of steps taken, calories burned, sleep quality, and/or other suitable sensor data. Health data also may be received via user input, from population data models (e.g., average health data related to persons of similar age, weight, height, race, gender, etc.), and/or from any other suitable source. The health data may be received over time and at least some components of the health data may be saved in memory of the computing device.

At 404, the health data is processed to determine one or more health outcomes, e.g. health benefits and efficiencies, related to the performing of certain health activities. Examples of health outcomes include sleep quality (e.g. hours slept, restlessness during sleep), exercise efficiency (e.g. calories burned per minute, total calories burned, heart rate), and potentially other outcomes such as body weight, body mass index, and weight loss.

At 406, method 400 includes determining a baseline value for each health outcome. The baseline value may represent a statistical value, such as an average, expected, and/or default value, for a corresponding health outcome. For example, the baseline value may be a representative value that reflects the value for that health outcome hat is typically observed for that user. The baseline values may be determined from population data (e.g., collected from other users' devices), past health data for the user, and/or personal and demographic data (e.g., user height, weight, age, gender). Additionally, as more health data is collected over time, the baseline values may be continually updated, as illustrated in FIG. 4 by the loop from 406 to 402. The baseline values may be determined differently for different health outcomes. For example, the baseline value for user heart rate may be an average maximum heart rate, while the baseline value for sleep quality may be a mode value (e.g., the sleep quality most often observed for the user). Further, in some examples, the baseline values may be based on recently collected health data, such as health data collected within the previous n days, where n may be any suitable number, such as 14, 28, 60, etc. In other examples, the baseline values may be based on health data collected over a longer period of time, such as the past year, two years, since the device was obtained by the user, etc.

The method 400 further includes, at 408, receiving work data relating to the user's work activities, which may include personal and group work activities. Work data may include data such as hours worked, time spent at the office/work facility, work-related events such as meetings or business travel, and work productivity (e.g. keystrokes, mouse clicks, tasks completed, web searches performed, number or type of documents edited, or applications used). Work data may be obtained in any suitable manner. As described above, in some examples, work data may be directly input by the user, and/or may be obtained from the user's calendar data in which the user has previously input a work schedule. In other examples, work data may be inferred, such as from GPS data that may indicate a user going to and from a work location, or from email data that may indicate when a user is logged in to a work email address or has received and sent email correspondences related to work. In yet other examples, work data may be obtained from a work access monitoring system used by an employer, including an employee time entry system, work timesheets, employee work schedules, payroll, etc.

At 410, the method 400 determines if a health outcome has deviated from the baseline value for that health outcome. The determination of whether the health outcome has deviated from the baseline value may be performed periodically, such as once every 24 hours, once a week, or other suitable frequency. In other examples, the determination may be performed substantially continuously. In one example, to determine if the health outcome has deviated from the baseline value for the health outcome, the method may include comparing a suitable representative value for the health outcome over a period of time (e.g., an overall average value, maximum value, minimum value, median value, instantaneous value, etc. over the period of time) to the baseline value, and if the value for the health outcome differs from the baseline value by more than a threshold amount, a deviation may be determined. Any suitable threshold may be used, such as one or two standard deviations from the mean of the values for the health outcome. Further, in some examples the threshold may vary based on the health outcome (e.g., a relatively large difference in user heart rate may be tolerated before a deviation is indicated, compared to sleep duration). In still further examples, the threshold may be global (e.g., based on data for all users), based on cohort data for similar users, or individual (e.g., based on data of just the user).

In some examples, the deviation may be indicated based at least on the value for the health outcome being less than the baseline value e.g., a deviation in sleep quality may only be indicated when the measured sleep quality is lower than the baseline sleep quality for that user). In other examples, the deviation may be indicated based at least on the health outcome being greater than the baseline value (e.g., a deviation in heart rate may only be indicated when the measured heart rate is greater than the baseline heart rate for that user).

If a deviation in the health outcome is not detected, method 400 loops back to 402 to continue monitoring health data and work data. On the other hand, if a deviation in the health outcome is detected, then method 400 proceeds to 414 to analyze the work data collected over a given time period preceding the deviation. For example, the work data representing work activities the user participated in during a 24-hour time period preceding the deviation may be analyzed, the work data representing work activities the user participated in during a five-day time period preceding the deviation may be analyzed, or the like.

At 416, method 400 determines a level of correlation between the health outcome and one or more parameters of the work data. The level of correlation may be determined in a suitable manner, such as according to one or more of the algorithms described above with respect to FIG. 3.

At 418, method 400 determines whether the level of correlation is greater than a threshold level. Any suitable method may be used for this determination. In some examples, the level of correlation may include a numerical value (e.g., between 0 and 1) and the threshold may be a suitable level that indicates at least some correlation (such as 0.5) or that indicates a level of correlation (0.9 or the like). Further, the more deviations in the health outcome that have been observed, the more robust the level of correlation may be, and hence the threshold may increase over time.

Based at least on the level of correlation not being greater than the threshold, method 400 returns to 402 to continue monitoring health data and work data, for example repeating the process for additional health outcomes. On the other hand, based upon the level of correlation being greater than the threshold, the method proceeds to 422 to output a notification of an insight regarding the correlation. The insight may include, for example, an indication to the user that the deviation in the health outcome may be correlated with a particular parameter of the user's work activities. Further, in some examples, the notification may include a recommendation to the user regarding scheduling of future work activities. For example, if it is determined that too many consecutive meetings leads to disrupted sleep, the notification may include a recommendation to reschedule future meetings that may otherwise result in a long duration of meetings. In another example, if it is determined that meetings held at a particular location (e.g., across campus) increase the number of calories burned (e.g., because the user typically walks to the meeting), the notification may include a recommendation to attend a meeting scheduled at that location in person rather than calling in to the meeting.

Further, the notification may take into account other activities (whether work-related, health-related, or personal) the user has scheduled when making recommendations. For example, if it is determined that working from home results in a more efficient or longer workout that day, the notification may include a recommendation to work from home on a future day where a lengthy or important marathon training session is scheduled.

In the example explained above with respect to FIG. 1C, the notification included a recommendation to reschedule a future meeting, and the notification also included an option to reschedule the meeting and an option not to reschedule the meeting. In such examples where the user is given a choice to accept or not accept the recommendation, the device may collect data following the recommendation to assess whether following or not following the recommendation impacted health outcomes in the manner predicted. For example, in the example presented above with respect to FIG. 1C, if the user were to select “cannot reschedule,” changes in the user's sleep that night could be used to evaluate the performance of the prediction and demonstrate to the user at a future time that their sleep was adversely affected.

While method 400 described above includes identification of a health outcome deviation and corresponding correlation with a work activity parameter, it is to be understood that the method may monitor health data for a number of health outcomes at the same time, and a plurality of health outcomes could be analyzed to determine multiple deviations from baseline values. For example, deviations in both sleep quality and exercise efficiency may be identified in one time period (e.g., twenty-four hours) and one or more multi-correlation algorithms may be applied to determine one or more work activities correlating to the deviations in the health outcomes.

In some examples, health data and work data may be further utilized to determine times in which the user may not need to operate the mobile device, wearable device, desktop computer, etc. that is implementing the method 400. For example, if it is determined that the user is scheduled to attend a work meeting from 2-4 PM, it is unlikely that the user will be operating the device during that time. Further, because attending a work meeting may not result in noteworthy changes in health metrics, e.g. heart rate, calories burned, etc., continuously acquiring sensor data during this period may also not be as important as gathering data at other times. Similarly, while working out in a gym or miming outdoor, the user is unlikely to operate a desktop PC at the same time. As such, the device may also recommend a power state, for example by outputting a recommendation to the user to charge the device during the work meeting or to shut down the device during the work meeting. Similar scenarios can be applied to other user devices as well, such as a user's personal computer.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows an example computing system 500 that may enact one or more of the methods and processes described above. The computing system 500 is shown in simplified form. The computing system 500 may take the form of one or more personal computers, server computers, tablet computers, home-entertainment computers, network computing devices, gaming devices, mobile computing devices, mobile communication devices (e.g., smart phone), and/or other computing devices. The various computing devices and wearable devices described earlier herein may be examples of computing system 500.

The computing system 500 includes a logic subsystem 502 and a storage subsystem 504. The computing system 500 may optionally include a display subsystem 506, input subsystem 508, communication subsystem 510, and/or other components not shown in FIG. 5.

The logic subsystem 502 includes one or more physical devices configured to execute instructions. For example, the logic subsystem 502 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. The logic subsystem 502 may also include a correlating subsystem, as described above with regard to FIG. 3, configured to correlate health outcomes with work activities, for example.

The logic subsystem 502 may include one or more processors configured to execute software instructions. Additionally or alternatively, the logic subsystem 502 may include one or more hardware or firmware logic machines configured to execute hardware or firmware instructions. Processors of the logic subsystem 502 may be single-core or multi-core, and the instructions executed thereon may be configured for sequential, parallel, and/or distributed processing. Individual components of the logic subsystem 502 optionally may be distributed among two or more separate devices, which may be remotely located and/or configured for coordinated processing. Aspects of the logic subsystem 502 may be virtualized and executed by remotely accessible, networked computing devices configured in a cloud-computing configuration.

The storage subsystem 504 includes one or more physical devices configured to hold instructions executable by the logic subsystem 502 to implement the methods and processes described herein. When such methods and processes are implemented, the state of the storage subsystem 504 may be transformed—e.g., to hold different data.

The storage subsystem 504 may include removable and/or built-in devices. The storage subsystem 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage subsystem 504 may include volatile, nonvolatile, dynamic, static, read/write, read-only, random-access, sequential-access, location-addressable, file-addressable, and/or content-addressable devices.

It will be appreciated that storage subsystem 504 includes one or more physical devices. However, aspects of the instructions described herein alternatively may be propagated by a communication medium (e.g., an electromagnetic signal, an optical signal, etc.) that is not held by a physical device for a finite duration.

Aspects of the logic subsystem 502 and storage subsystem 504 may be integrated together to one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

When included, the display subsystem 506 may be used to present a visual representation of data held by the storage subsystem 504. This visual representation may take the form of a graphical user interface (GUI). As the herein described methods and processes change the data held by the storage machine, and thus transform the state of the storage machine, the state of the display subsystem 506 may likewise be transformed to visually represent changes in the underlying data. The display subsystem 506 may include one or more display devices utilizing virtually any type of technology. Such display devices may be combined with the logic subsystem 502 and/or storage subsystem 504 in a shared enclosure, or such display devices may be peripheral display devices.

When included, the input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication subsystem 510 may be configured to communicatively couple the computing system 500 with one or more other computing devices. The communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow the computing system 500 to send and/or receive messages to and/or from other devices via a network such as the Internet.

The computing system 500 may further include correlation subsystem 512 where data analytics and modeling tasks are performed. In some examples, the correlation subsystem 512 may receive signals from the input subsystem 508 and output the results through the communication subsystems 510 and/or display subsystem 506. The correlation subsystem 512 may have any suitable hardware and/or software configuration via the logic subsystem 502 and the storage subsystem 504.

Another example provides for a computing device comprising a logic subsystem comprising a logic device; and a storage subsystem comprising a storage device, the storage subsystem comprising instructions executable by the logic subsystem to monitor health data relating to health behavior of a user over time; determine a baseline value for a health outcome of the user based on the monitored health data; receive work data relating to a work schedule of the user; responsive to the health outcome deviating from the baseline value, determine that the deviation in the health outcome correlates with the work data; and based at least upon determining that the deviation in the health outcome correlates with the work data, output a notification of the determination to the user. The computing device additionally or alternatively further comprises one or more sensors configured to collect the health data, where the one or more sensors are configured to measure one or more of heart rate, skin temperature, galvanic skin response, number of steps taken, calories burned, moving distance, standing time, sleep duration, and sleep quality. The instructions are additionally or alternatively executable to update the baseline value as additional health data is collected over time The work data additionally or alternatively includes information regarding one or more of meetings, emails, web searches, locations, applications used, work schedules, edited documents, and work productivity. The instructions are additionally or alternatively executable to receive the work data via one or more of user input, a personal calendar. Global Positioning System data, user input data, email data, and a work access monitoring system. The health outcome additionally or alternatively comprises one or more of a sleep quality and a sleep duration for a given day, the instructions are additionally or alternatively executable to determine if a deviation in the one or more of the sleep quality and the sleep duration correlates with a meeting schedule of the user on the given day, and the notification additionally or alternatively includes a recommendation to reschedule one or more future meetings. The computing device additionally or alternatively further comprises a display, and the instructions are additionally or alternatively executable to output the notification of the determination by displaying a recommendation to adjust one or more aspects of a future work day of the user. The recommendation to adjust the one or more aspects of the future work day of the user additionally or alternatively comprises a recommendation to adjust one or more of a meeting schedule, a work schedule, a number of emails sent, and a number of web searches performed. Any or all of the above-described examples may be combined in any suitable manner in various implementations.

Another example provides for, on a computing device, a method comprising monitoring health data of a user over time; determining a baseline value for each of a plurality of health outcomes based on the monitored health data; receiving work data of the user; responsive to a first health outcome of the plurality of health outcomes deviating from a baseline value for the first health outcome, determining that the deviation in the first health outcome correlates with the work data; and based at least on determining that the deviation correlates with the work data, outputting a notification of the determination to the user. Determining the baseline value for each of the plurality of health outcomes additionally or alternatively comprises determining one or more of a baseline heart rate, a baseline stress level, a baseline number of steps taken, a baseline calories burned, a baseline moving distance, a baseline standing time, a baseline sleep duration, and a baseline sleep quality of the user. Receiving work data of the user additionally or alternatively comprises receiving data relating to one or more of meetings, emails, web searches, locations, applications used, work schedules, edited documents, and work productivity of the user. The method additionally or alternatively further comprises determining the deviation in the first health outcome by determining a mean value for the first health outcome over the period of time, and determining that the first health outcome deviates from the baseline value for the first health outcome when the mean value for the first health outcome differs from the baseline value for the first health outcome by more than a threshold amount. Determining that the deviation in the first health outcome correlates with the work data additionally or alternatively comprises analyzing the work data received during the period of time to determine that a parameter of the work data deviates from an expected parameter during a period of time; and based at least on the parameter deviating from the expected parameter, outputting a level of correlation between the parameter of the work data and the first heath outcome, the deviation in the first health outcome correlating with the work data determined responsive to the level of correlation exceeding a threshold level. The first health outcome additionally or alternatively comprises a sleep quality of the user during the period of time, and analyzing the work data received during the period of time additionally or alternatively comprises analyzing the work data received during the period of time to determine that one or more of a number, a duration, a location, and a timing of work meetings during the period of time is different than a corresponding average value; and based at least upon determining that the one or more of the number, the duration, the location, and the timing of work meetings during the period of time is different than the average value, outputting the notification of the determination to the user by outputting a recommendation for future meeting scheduling. Outputting the recommendation for future meeting scheduling additionally or alternatively comprises outputting a recommendation to adjust one or more of a timing and a location of one or more future scheduled meetings. Any or all of the above-described examples may be combined in any suitable manner in various implementations.

Another example provides for a computing device comprising a logic subsystem comprising a logic device; and a storage subsystem comprising a storage device, the storage subsystem comprising instructions executable by the logic subsystem to receive health data relating to health behavior of a user; process the health data to determine one or more health outcomes of the user, the one or more health outcomes including a sleep outcome of the user; receive work data relating to a work schedule of the user; responsive to the sleep outcome deviating from a baseline sleep outcome, determine that a level of correlation between the sleep outcome of the user and the work schedule of the user is greater than a threshold level; and based at least on determining that the level of correlation exceeds the threshold level, output a notification of the determination to the user. The instructions are additionally or alternatively executable to process one or more of the health data and work data to determine a suggested time of day for recharging the device and output a notification of the suggested time of day to the user. The computing device additionally or alternatively further comprises a display, and the instructions are additionally or alternatively executable to output the notification of the determination by displaying a recommendation to adjust one or more aspects of a future work day of the user. The recommendation to adjust the one or more aspects of the future work day of the user additionally or alternatively comprises a recommendation to adjust a meeting schedule The instructions are additionally or alternatively executable to receive the work data via one or more of user input, a personal calendar, Global Positioning System data, user input data, email data, and a work access monitoring system. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a logic subsystem comprising a logic device; and
a storage subsystem comprising a storage device, the storage subsystem comprising instructions executable by the logic subsystem to
monitor health data relating to health behavior of a user over time;
determine a baseline value for a health outcome of the user based on the monitored health data;
receive work data relating to a work schedule of the user;
responsive to the health outcome deviating from the baseline value, determine that the deviation in the health outcome correlates with the work data; and
based at least upon determining that the deviation in the health outcome correlates with the work data, output a notification of the determination to the user.

2. The computing device of claim 1, further comprising one or more sensors configured to collect the health data, where the one or more sensors are configured to measure one or more of heart rate, skin temperature, galvanic skin response, number of steps taken, calories burned, moving distance, standing time, sleep duration, and sleep quality.

3. The computing device of claim 2, wherein the instructions are executable to update the baseline value as additional health data is collected over time.

4. The computing device of claim 1, wherein the work data includes information regarding one or more of meetings, emails, web searches, locations, applications used, work schedules, edited documents, and work productivity.

5. The computing device of claim 1, wherein the instructions are executable to receive the work data via one or more of user input, a personal calendar, Global Positioning System data, user input data, email data, and a work access monitoring system.

6. The computing device of claim 1, wherein the health outcome comprises one or more of a sleep quality and a sleep duration for a given day, wherein the instructions are executable to determine if a deviation in the one or more of the sleep quality and the sleep duration correlates with a meeting schedule of the user on the given day, and wherein the notification includes a recommendation to reschedule one or more future meetings.

7. The computing device of claim 1, further comprising a display, and wherein the instructions are executable to output the notification of the determination by displaying a recommendation to adjust one or more aspects of a future work day of the user.

8. The computing device of claim 7, wherein the recommendation to adjust the one or more aspects of the future work day of the user comprises a recommendation to adjust one or more of a meeting schedule, a work schedule, a number of emails sent, and a number of web searches performed.

9. On a computing device, a method, comprising:
monitoring health data of a user over time;
determining a baseline value for each of a plurality of health outcomes based on the monitored health data;
receiving work data of the user;
responsive to a first health outcome of the plurality of health outcomes deviating from a baseline value for the first health outcome, determining that the deviation in the first health outcome correlates with the work data; and
based at least on determining that the deviation correlates with the work data, outputting a notification of the determination to the user.

10. The method of claim 9, wherein determining the baseline value for each of the plurality of health outcomes comprises determining one or more of a baseline heart rate, a baseline stress level, a baseline number of steps taken, a baseline calories burned, a baseline moving distance, a baseline standing time, a baseline sleep duration, and a baseline sleep quality of the user.

11. The method of claim 9, wherein receiving work data of the user comprises receiving data relating to one or more of meetings, emails, web searches, locations, applications used, work schedules, edited documents, and work productivity of the user.

12. The method of claim 9, further comprising determining the deviation in the first health outcome by determining a mean value for the first health outcome over the period of time, and determining that the first health outcome deviates from the baseline value for the first health outcome when the mean value for the first health outcome differs from the baseline value for the first health outcome by more than a threshold amount.

13. The method of claim 12, wherein determining that the deviation in the first health outcome correlates with the work data comprises:
analyzing the work data received during the period of time to determine that a. parameter of the work data deviates from an expected parameter during a period of time; and
based at least on the parameter deviating from the expected parameter, outputting a level of correlation between the parameter of the work data and the first heath outcome, the deviation in the first health outcome correlating with the work data determined responsive to the level of correlation exceeding a threshold level.

14. The method of claim 13, wherein the first health outcome comprises a sleep quality of the user during the period of time, and wherein
analyzing the work data received during the period of time comprises analyzing the work data received during the period of time to determine that one or more of a number, a duration, a location, and a timing of work meetings during the period of time is different than a corresponding average value; and
based at least upon determining that the one or more of the number, the duration, the location, and the timing of work meetings during the period of time is different than the average value, outputting the notification of the determination to the user by outputting a recommendation for future meeting scheduling.

15. The method of claim 14, wherein outputting the recommendation for future meeting scheduling comprises outputting a recommendation to adjust one or more of a timing and a location of one or more future scheduled meetings.

16. A computing device, comprising:
a logic subsystem comprising a logic device; and
a storage subsystem comprising a storage device, the storage subsystem comprising instructions executable by the logic subsystem to
receive health data relating to health behavior of a user;
process the health data to determine one or more health outcomes of the user, the one or ore health outcomes including a sleep outcome of the user;
receive work data relating to a work schedule of the user;
responsive to the sleep outcome deviating from a baseline sleep outcome, determine that a level of correlation between the sleep outcome of the user and the work schedule of the user is greater than a threshold level; and
based at least on determining that the level of correlation exceeds the threshold level, output a notification of the determination to the user.

17. The computing device of claim 16, wherein the instructions are executable to process one or more of the health data and work data to determine a suggested time of day for recharging the device and output a notification of the suggested time of day to the user.

18. The computing device of claim 16, further comprising a display, and wherein the instructions are executable to output the notification of the determination by displaying a recommendation to adjust one or more aspects of a future work day of the user.

19. The computing device of claim 18, wherein the recommendation to adjust the one or more aspects of the future work day of the user comprises a recommendation to adjust a meeting schedule.

20. The computing device of claim 16, wherein the instructions are executable to receive the work data via one or more of user input, a personal calendar, Global Positioning System data, user input data, email data, and a work access monitoring system.
